(19) United States
(12) Patent Application Publication
(10) Pub. No.: US 2012/0061024 A1
(43) Pub. Date: Mar. 15, 2012

(54) MOLD AND METHOD FOR PRODUCING A ROTOR BLADE

(76) Inventor: Andreas STARKE, Rheine (DE)

(21) Appl. No.: 13/211,981

(22) Filed: Aug. 17, 2011

(51) Int. Cl. B29C 70/44; B23P 11/00

(52) U.S. Cl. 156/475; 29/428

(57) ABSTRACT

A mold module of a modular mold for a wind turbine rotor blade is provided, the mold module including at least one mold body having an inverse shape of a part of a rotor blade; at least one support structure for supporting the at least one mold body; and, at least one flange attached to an end portion of the at least one mold body to releasably mount said mold module to a further mold module of that modular mold.

### BACKGROUND OF THE INVENTION

The subject matter described herein relates generally to methods and systems for the production of rotor blades, and more particularly, to methods and systems for producing rotor blades for wind turbines.

At least some known wind turbines include a tower and a nacelle mounted on the tower. A rotor is rotatably mounted to the nacelle and is coupled to a generator by a shaft. A plurality of blades extend from the rotor. The blades are oriented such that wind passing over the blades turns the rotor and rotates the shaft, thereby driving the generator to generate electricity.

Rotor blades for wind turbines are typically produced by laminating a structure into a prefabricated mold. The mold includes a support structure, typically a steel framework, and the mold body, which is an inverse form of the rotor blade to be produced. Thereby, two molds are applied for producing a wind turbine rotor blade, one for the half of the suction side of the rotor blade, and one for the half of the pressure side of the rotor blade.

The shape of the mold defines properties of the produced rotor blade like length, width, thickness, sweep, prebend, and twist angle. The mold itself typically includes compound materials like fiberglass, carbon fiber, or combinations thereof. Furthermore, the mold is relatively easy to deform and is thus stabilized by a support structure typically comprising steel elements during the production process.

Typically, the tooling process for producing the mold is time-consuming and requires a significant amount of handwork. Conventionally, the two halves mentioned above were each fabricated to cover the entire length of a rotor blade, i.e., the upper and lower mold are each formed as one continuous piece of material, for example of fiberglass. As the length of a rotor blade can be in the range of more than 100 m, the production and handling of such molds is cumbersome and extremely time intensive.

Due to the need of shortening development cycles and of making the production process more flexible, manufacturers of rotor blades have started to reuse parts of existing molds when building new molds for different models of a rotor blade. For example, a central section of a mold may be separated from the tip section of the mold and be attached to a new tip section of the mold, which may for example be shorter, or longer. Conventionally, this was carried out by mechanically separating the existing mold into modules, which could then subsequently be reused when combined with other modules, for example with other tip sections having different lengths. This process involves destructive techniques, as the existing molds are typically divided into parts by sawing or by using cutting discs and the like.

Subsequently, a module of the mold, for example the central section (in a longitudinal direction) is combined with a new tip section. This is usually carried out by laminating the new parts together, using a binding paste which typically includes epoxy resin, and by subsequently grinding the newly laminated section between the parts in order to achieve a smooth surface necessary for the molding process. The transition region between the newly mounted parts also has to be vacuum tight after joining the parts, as the rotor blade is produced by infusing resin by application of a vacuum to the stacked compound materials of the rotor blade.

The above described method involves a lot of handwork and is time consuming, as many labor intensive steps have to be carried out. Further, to maintain a high quality of the newly fabricated molds is difficult, for example due to the partly destructive process. Furthermore the process can not be repeated often, as the same section of the reused mold section would have to be cut and reworked again and again, which worsens the quality of the laminate material at the intersections.

In view of the above, there is a desire for having an improved method for exchanging parts of mold bodies for rotor blades, as well as an improved mold system.

### BRIEF DESCRIPTION OF THE INVENTION

In one aspect, a mold module of a modular mold for a wind turbine rotor blade is provided. The mold module includes at least one mold body having an inverse shape of a part of a rotor blade; at least one support structure for supporting the at least one mold body; and, at least one flange attached to an end portion of the at least one mold body to releasably mount said mold module to a further mold module of that modular mold.

In another aspect, a modular mold for a wind turbine rotor blade is provided. The modular mold includes at least two elongated mold modules, each mold module including at least one mold body and at least one support structure for supporting the at least one mold body; and at least one flange attached to an end portion of the mold body, wherein the at least two elongated mold modules are releasably mounted together via at least two flanges.

In yet another aspect, a method for building a mold for a wind turbine rotor blade is provided. The method includes providing two mold modules, each comprising at least one mold body having an inverse shape of a part of a rotor blade, at least one support structure for supporting the mold body, and, at least one flange attached to an end portion of the mold body; positioning the two mold modules such that their flanges are in contact; and releasably connecting the two flanges.

### BRIEF DESCRIPTION OF THE DRAWINGS

A full and enabling disclosure including the best mode thereof, to one of ordinary skill in the art, is set forth more particularly in the remainder of the specification, including reference to the accompanying figures wherein:

FIG. 1 is a perspective view of an exemplary wind turbine.

FIG. 2 is an enlarged sectional view of a portion of the wind turbine shown in FIG. 1.

FIG. 3 is a perspective view of a modular mold according to embodiments.

FIG. 4 is a cross sectional view of the modular mold of FIG. 3.

FIG. 5 is a detailed sectional view of the embodiments of FIG. 4.

FIG. 6 is a schematic backside view of a flange for a modular mold according to embodiments.

FIG. 7 is a flow chart showing a method according to embodiments.

### DETAILED DESCRIPTION OF THE INVENTION

Reference will now be made in detail to the various embodiments, one or more examples of which are illustrated in each figure. Each example is provided by way of explanation and is not meant as a limitation. For example, features illustrated or described as part of one embodiment can be used on or in conjunction with other embodiments to yield yet further embodiments. It is intended that the present disclosure includes such modifications and variations.

The embodiments described herein relate to mold modules for producing wind turbine rotor blades, which can be joined together by flanges. More particularly, they relate to a method of joining modular mold modules in order to obtain a mold for a wind turbine rotor blade

As used herein, the term “blade” is intended to be representative of any device that provides a reactive force when in motion relative to a surrounding fluid. As used herein, the term “wind turbine” is intended to be representative of any device that generates rotational energy from wind energy, and more specifically, converts kinetic energy of wind into mechanical energy. As used herein, the term “wind generator” is intended to be representative of any wind turbine that generates electrical power from rotational energy generated from wind energy, and more specifically, converts mechanical energy converted from kinetic energy of wind to electrical power.

As used herein, the term “releasably connected” is intended to be representative of any connection method which can subsequently be disconnected without any destructive or disruptive measures or techniques used in the disconnection process. For example, a connection using nuts and bolts is regarded as “releasable”, while a connection via laminating two modules together, or welding, is non-releasable, as the connection has to be physically destructed to separate or disconnect the modules. As used herein, the term “mold body” is intended to stand representative for a body that is used as a mold in a production process. Thereby, the mold body may include a variety of different materials or compound materials, such as glass fiber or plastic. The mold body is included in the mold, which also includes further parts like a support structure for the mold body. As used herein, the term “laminate” is intended to be representative of a composite material which includes a fibrous material or a fabric, such as glass fiber and/or carbon fiber, and a resin, such as polyester resin, epoxy resin etc. As used herein, the term “laminating” is intended to stand for the process or the activity of working with the above materials in order to create a laminate as described above.

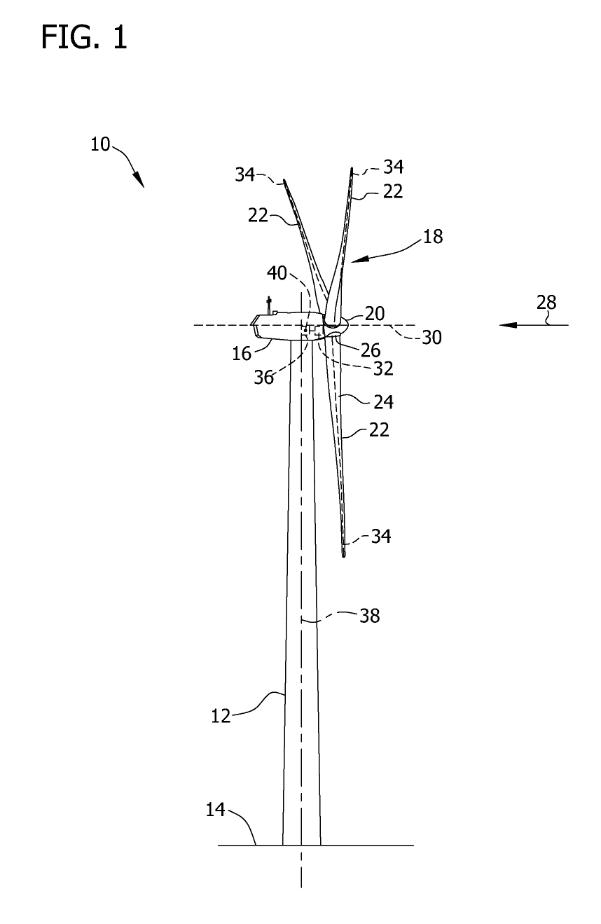

FIG. 1 is a perspective view of an exemplary wind turbine 10. In the exemplary embodiment, wind turbine 10 is a horizontal-axis wind turbine. Alternatively, wind turbine 10 may be a vertical-axis wind turbine. In the exemplary embodiment, wind turbine 10 includes a tower 12 that extends from a support system 14, a nacelle 16 mounted on tower 12, and a rotor 18 that is coupled to nacelle 16. Rotor 18 includes a rotatable hub 20 and at least one rotor blade 22 coupled to and extending outward from hub 20. In the exemplary embodiment, rotor 18 has three rotor blades 22. In an alternative embodiment, rotor 18 includes more or less than three rotor blades 22. In the exemplary embodiment, tower 12 is fabricated from tubular steel to define a cavity (not shown in FIG. 1) between support system 14 and nacelle 16. In an alternative embodiment, tower 12 is any suitable type of tower having any suitable height.

Rotor blades 22 are spaced about hub 20 to facilitate rotating rotor 18 to enable kinetic energy to be transferred from the wind into usable mechanical energy, and subsequently, electrical energy. Rotor blades 22 are mated to hub 20 by coupling a blade root portion 24 to hub 20 at a plurality of load transfer regions 26. Load transfer regions 26 have a hub load transfer region and a blade load transfer region (both not shown in FIG. 1). Loads induced to rotor blades 22 are transferred to hub 20 via load transfer regions 26.

In one embodiment, rotor blades 22 have a length ranging from about 15 meters (m) to about 91 m. Alternatively, rotor blades 22 may have any suitable length that enables wind turbine 10 to function as described herein. For example, other non-limiting examples of blade lengths include 10 m or less, 20 m, 37 m, or a length that is greater than 91 m. As wind strikes rotor blades 22 from a direction 28, rotor 18 is rotated about an axis of rotation 30. As rotor blades 22 are rotated and subjected to centrifugal forces, rotor blades 22 are also subjected to various forces and moments. As such, rotor blades 22 may deflect and/or rotate from a neutral, or non-deflected, position to a deflected position.

Moreover, a pitch angle or blade pitch of rotor blades 22, i.e., an angle that determines a perspective of rotor blades 22 with respect to direction 28 of the wind, may be changed by a pitch adjustment system 32 to control the load and power generated by wind turbine 10 by adjusting an angular position of at least one rotor blade 22 relative to wind vectors. Pitch axes 34 for rotor blades 22 are shown. During operation of wind turbine 10, pitch adjustment system 32 may change a blade pitch of rotor blades 22 such that rotor blades 22 are moved to a feathered position, such that the perspective of at least one rotor blade 22 relative to wind vectors provides a minimal surface area of rotor blade 22 to be oriented towards the wind vectors, which facilitates reducing a rotational speed of rotor 18 and/or facilitates a stall of rotor 18.

In the exemplary embodiment, a blade pitch of each rotor blade 22 is controlled individually by a control system 36. Alternatively, the blade pitch for all rotor blades 22 may be controlled simultaneously by control system 36. Further, in the exemplary embodiment, as direction 28 changes, a yaw direction of nacelle 16 may be controlled about a yaw axis 38 to position rotor blades 22 with respect to direction 28.

In the exemplary embodiment, control system 36 is shown as being centralized within nacelle 16, however, control system 36 may be a distributed system throughout wind turbine 10, on support system 14, within a wind farm, and/or at a remote control center. Control system 36 includes a processor 40 configured to perform the methods and/or steps described herein. Further, many of the other components described herein include a processor. As used herein, the term “processor” is not limited to integrated circuits referred to in the art as a computer, but broadly refers to a controller, a microcontroller, a microcomputer, a programmable logic controller (PLC), an application specific integrated circuit, and other programmable circuits, and these terms are used interchangeably herein. It should be understood that a processor and/or a control system can also include memory, input channels, and/or output channels.

In the embodiments described herein, memory may include, without limitation, a computer-readable medium, such as a random access memory (RAM), and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, input channels include, without limitation, sensors and/or computer peripherals associated with an operator interface, such as a mouse and a keyboard. Further, in the exemplary embodiment, output channels may include, without limitation, a control device, an operator interface monitor and/or a display.

Processors described herein process information transmitted from a plurality of electrical and electronic devices that may include, without limitation, sensors, actuators, compressors, control systems, and/or monitoring devices. Such processors may be physically located in, for example, a control system, a sensor, a monitoring device, a desktop computer, a laptop computer, a programmable logic controller (PLC) cabinet, and/or a distributed control system (DCS) cabinet. RAM and storage devices store and transfer information and instructions to be executed by the processor(s). RAM and storage devices can also be used to store and provide temporary variables, static (i.e., non-changing) information and instructions, or other intermediate information to the processors during execution of instructions by the processor(s). Instructions that are executed may include, without limitation, wind turbine control system control commands The execution of sequences of instructions is not limited to any specific combination of hardware circuitry and software instructions.

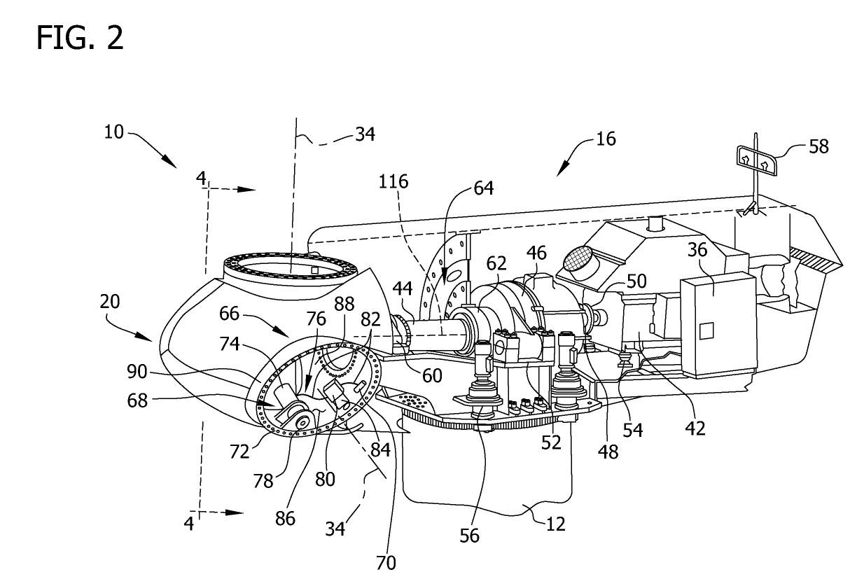

FIG. 2 is an enlarged sectional view of a portion of wind turbine 10. In the exemplary embodiment, wind turbine 10 includes nacelle 16 and hub 20 that is rotatably coupled to nacelle 16. More specifically, hub 20 is rotatably coupled to an electric generator 42 positioned within nacelle 16 by rotor shaft 44 (sometimes referred to as either a main shaft or a low speed shaft), a gearbox 46, a high speed shaft 48, and a coupling 50. In the exemplary embodiment, rotor shaft 44 is disposed coaxial to longitudinal axis 116. Rotation of rotor shaft 44 rotatably drives gearbox 46 that subsequently drives high speed shaft 48. High speed shaft 48 rotatably drives generator 42 with coupling 50 and rotation of high speed shaft 48 facilitates production of electrical power by generator 42. Gearbox 46 and generator 42 are supported by a support 52 and a support 54. In the exemplary embodiment, gearbox 46 utilizes a dual path geometry to drive high speed shaft 48. Alternatively, rotor shaft 44 is coupled directly to generator 42 with coupling 50.

Nacelle 16 also includes a yaw drive mechanism 56 that may be used to rotate nacelle 16 and hub 20 on yaw axis 38 (shown in FIG. 1) to control the perspective of rotor blades 22 with respect to direction 28 of the wind. Nacelle 16 also includes at least one meteorological mast 58 that includes a wind vane and anemometer (neither shown in FIG. 2). Mast 58 provides information to control system 36 that may include wind direction and/or wind speed. In the exemplary embodiment, nacelle 16 also includes a main forward support bearing 60 and a main aft support bearing 62.

Forward support bearing 60 and aft support bearing 62 facilitate radial support and alignment of rotor shaft 44. Forward support bearing 60 is coupled to rotor shaft 44 near hub 20. Aft support bearing 62 is positioned on rotor shaft 44 near gearbox 46 and/or generator 42. Alternatively, nacelle 16 includes any number of support bearings that enable wind turbine 10 to function as disclosed herein. Rotor shaft 44, generator 42, gearbox 46, high speed shaft 48, coupling 50, and any associated fastening, support, and/or securing device including, but not limited to, support 52 and/or support 54, and forward support bearing 60 and aft support bearing 62, are sometimes referred to as a drive train 64.

In the exemplary embodiment, hub 20 includes a pitch assembly 66. Pitch assembly 66 includes one or more pitch drive systems 68 and at least one sensor 70. Each pitch drive system 68 is coupled to a respective rotor blade 22 (shown in FIG. 1) for modulating the blade pitch of associated rotor blade 22 along pitch axis 34. Only one of three pitch drive systems 68 is shown in FIG. 2.

In the exemplary embodiment, pitch assembly 66 includes at least one pitch bearing 72 coupled to hub 20 and to respective rotor blade 22 (shown in FIG. 1) for rotating respective rotor blade 22 about pitch axis 34. Pitch drive system 68 includes a pitch drive motor 74, pitch drive gearbox 76, and pitch drive pinion 78. Pitch drive motor 74 is coupled to pitch drive gearbox 76 such that pitch drive motor 74 imparts mechanical force to pitch drive gearbox 76. Pitch drive gearbox 76 is coupled to pitch drive pinion 78 such that pitch drive pinion 78 is rotated by pitch drive gearbox 76. Pitch bearing 72 is coupled to pitch drive pinion 78 such that the rotation of pitch drive pinion 78 causes rotation of pitch bearing 72. More specifically, in the exemplary embodiment, pitch drive pinion 78 is coupled to pitch bearing 72 such that rotation of pitch drive gearbox 76 rotates pitch bearing 72 and rotor blade 22 about pitch axis 34 to change the blade pitch of blade 22.

Pitch drive system 68 is coupled to control system 36 for adjusting the blade pitch of rotor blade 22 upon receipt of one or more signals from control system 36. In the exemplary embodiment, pitch drive motor 74 is any suitable motor driven by electrical power and/or a hydraulic system that enables pitch assembly 66 to function as described herein. Alternatively, pitch assembly 66 may include any suitable structure, configuration, arrangement, and/or components such as, but not limited to, hydraulic cylinders, springs, and/or servo-mechanisms. Moreover, pitch assembly 66 may be driven by any suitable means such as, but not limited to, hydraulic fluid, and/or mechanical power, such as, but not limited to, induced spring forces and/or electromagnetic forces. In certain embodiments, pitch drive motor 74 is driven by energy extracted from a rotational inertia of hub 20 and/or a stored energy source (not shown) that supplies energy to components of wind turbine 10.

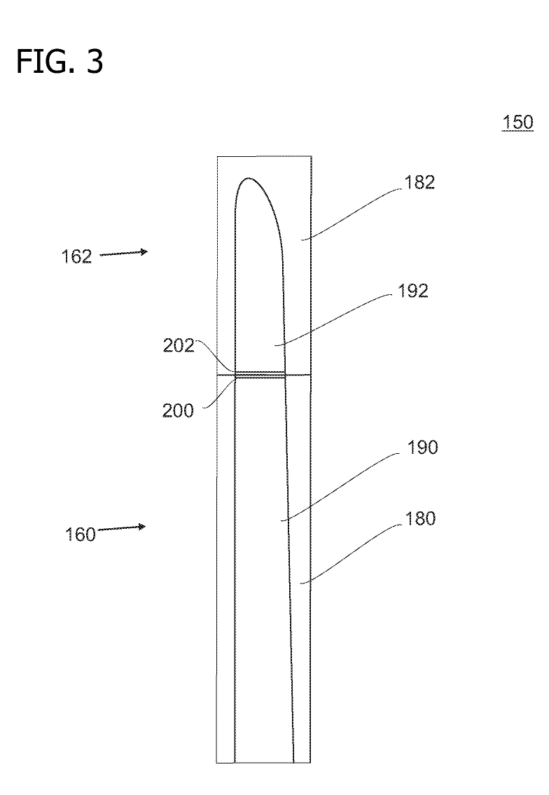

FIG. 3 shows a schematic top view of a modular mold 150 for a wind turbine rotor blade. The modular mold includes two elongated mold modules 160, 162. Each mold module includes a supporting section 180, 182 which supports a mold body 190, 192. The mold modules together form a mold having the inverse shape of a part of a wind turbine rotor blade (not shown) to be produced. The rotor blade is typically produced by the well-known process of laminating the blade structure into the mold 150. Typically, the mold bodies are designed such that one half of the blade is produced, hence that the mold bodies have the inverse form of one half of a rotor blade. After the lamination process, the two produced halves are laminated together to form the rotor blade. Embodiments described herein pertain to a mold for one half of a rotor blade. Typically, the mold bodies are designed such that a half representing the suction side of the rotor blade, or the half of the pressure side of the rotor blade are produced.

The mold bodies 190, 192 of the two mold modules 160, 162 are mounted together by flanges 200, 202. The flanges are each laminated respectively to an end portion of the mold bodies 190, 192, whereby the adjacent faces of the flanges which are connected to the other flange are directed away from the bodies of the respective mold bodies 190, 192.

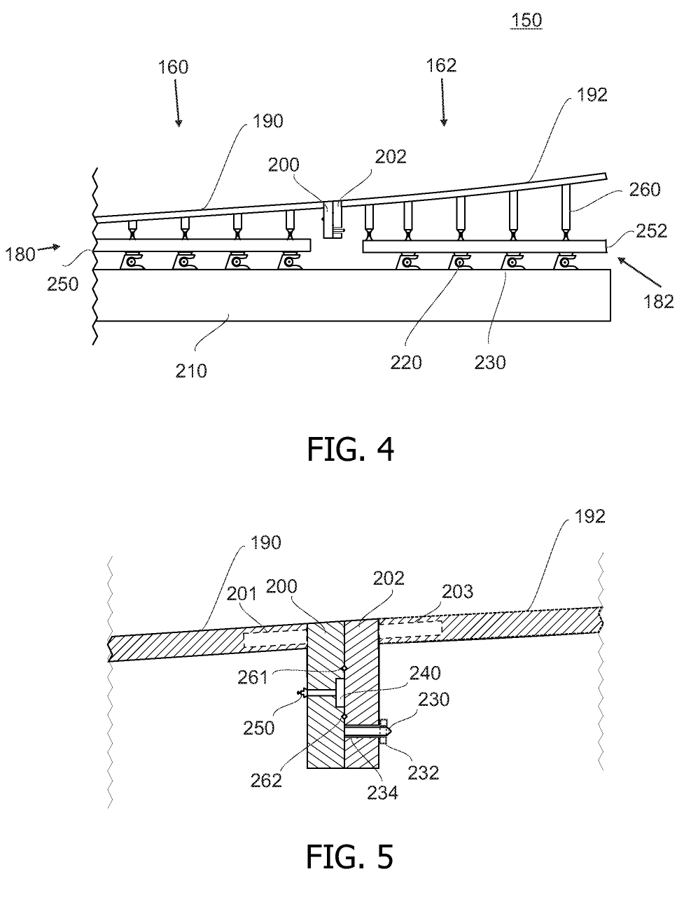

FIG. 4 shows a cross sectional side view of the mold 150 of FIG. 3. The mold 150 includes a bed plate 210, typically of solid metal, for example steel. The support structures 180, 182 are typically releasably mounted to the bed plate 210. The support structures include a plurality of locks 230 which are releasably fastened to bolts 220 or similar structural elements fastened to the bed plate 210. On locks 230, metal plates 250, 252 are positioned. On their upper side, orientated towards the mold bodies, the plates are mounted to supports 260 carrying the mold bodies 190, 192. When the mold modules 160, 162 are joined together, typically also the supporting structure is mounted together via fastening means like screws, bolts, and/or nuts. The nature of the supporting structure for the mold bodies 190, 192 is not of particular importance for the embodiments described herein, as long as it can be divided and mounted at the border between two mold modules 160, 162. Hence, in embodiments also other support constructions known to the skilled person may be employed.

The mold bodies are connected to each other at their adjacent ends with first flange 200 and second flange 202. Thereby, the typically L-shaped flanges are laminated to the end portions of the mold bodies 190, 192 in such a way, that on the side of the mold bodies facing the rotor blade to be produced, a smooth transition between the surfaces of the two mold bodies 200, 202 is achieved. The flanges are therefore typically laminated into the material of the mold bodies 190, 192, whereby one leg 201, 203 (dashed lines in FIG. 5) of each L-shaped flange is laminated into the mold body 190, 192. In other embodiments, the flanges may be attached to the mold body differently, e.g. by using screws. Typically, the flanges include or are made of steel, but may also include composite materials or other metals such as aluminum alloys, brass, or the like. As they do not have to carry particularly high loads, a type of steel can be chosen which is easily to mill. The legs of the L-shaped flanges typically enclose an angle of about 90°, but also other angles are possible, e.g. from 60° to 120°, more typically from 80° to 100°.

When a mold module 160, 162 is exchanged for another mold module, e.g. a tip module with a different length, the connection between the flanges 200, 202 is released. This may be carried out by loosening the employed screws, bolts 230, or the like, and/or by stopping to applicate a vacuum to the space enclosed by the flanges, in the embodiment groove 240. Further, if the support structures 180, 182 of the mold modules were connected, these connections have to be loosened, e.g. the locks 230 from bolts 220. Subsequently, the support structure 180, 182 is loosened from the bed plate 210 and the mold module to be replaced is transported to a storage area. A different mold module is positioned on the bed plate, the flanges are attached to each other, and the support structure is mounted to the bed plate 210.

In embodiments, the length of the mold bodies 190, 192, respectively the mold modules 160, 162, may have a length which is from 1% to 99% of the length of the produced rotor blades, more typically from 2% to 98%. For example, the mold module intended for a tip section may have a length of 1 m to 12 meters, more typically 2 m to 10 m, whereas a mold module for a center part of a rotor blade may have a length form 30 m to 120 m, more typically 40 m to 100 m. A mold body being adapted for producing a root portion, a center portion, or a tip portion of a rotor blade means that the mold body has the inverse shape of the respective portion and the length of the respective portion.

Typically, one of the mold modules 160, 162 is a module which is used for producing the center section of a wind turbine rotor. This section may be used in conjunction, for example, with different tip section mold modules having different lengths. Also, the root mold section may be replaced using the technique described herein.

FIG. 5 shows how the flanges 200, 202 may be connected according to embodiments, in a detailed view of the flange section of FIG. 4. The flanges may be connected using nuts 232 and bolts 230, hence the first flange may be equipped with stay bolts, or both flanges may include bores 234, through which bolts are inserted and fastened with nuts 232. Several methods of connecting flanges via screws or bolts are well known in the art.

In embodiments, the flanges may also be attached to each other by applying a vacuum to a space enclosed between the flanges 200, 202. To this end, a groove 240 may be milled or cast in the face of at least one of the flanges 200, 202. The groove typically extends over the width of the flange, its ends are distanced at least a few mm, for example 3 mm to 20 mm, from the side end of the flange, so that the groove is hermetically closed by an attached second flange. The groove 240 is connected via a channel and a connection 250 to an external vacuum pump (not shown).

Once the groove is evacuated, the ambient pressure presses the flange surfaces together, with a force easily derivable from the area of the groove and the ambient pressure. Thereby, the employed vacuum does not need to be high, for example 0.1 mbar to 100 mbar will suffice for the desired effect. As vacuum pumps are well known to persons skilled in the art, no further details are provided thereon.

As the flanges are rigidly connected to the mold bodies, this method serves for mounting the mold bodies 190, 192 together. In embodiments, the vacuum seal may be used independently from, and alternatively to, or in conjunction with the usage of screws, bolts, nuts, etc. as mentioned above.

During manufacturing of a rotor blade part, a compound is stacked in the mold body and a foil placed thereon. The space between the mold body and the foil is then connected to a vacuum pump, so that air is sucked out and the developing vacuum sucks in resin from a supply. Hence, the junction at the flanges 200, 202 between the mold bodies 190, 192 is vacuum tight. In order to improve the tightness, seals 261, 262 may be employed between the faces of the flanges. The seal may for example be an O-ring, or a gasket. A seat for the sealing may be provided in the surface of one or both flanges 200, 202, for example by milling.

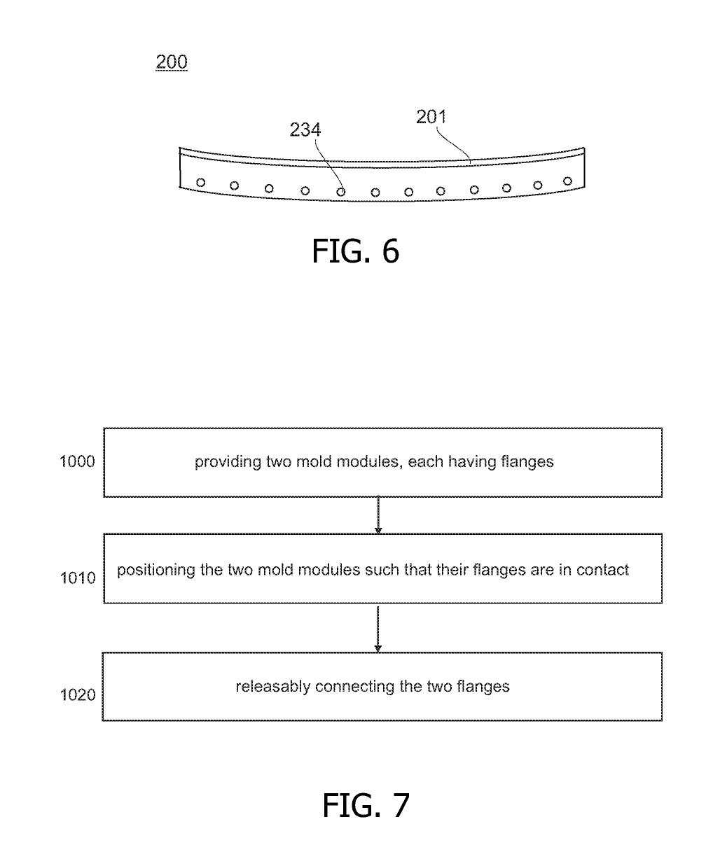

FIG. 6 shows a schematic backside view of a flange as used in embodiments described herein. “Backside” means that the face of the flange 200, 202 is shown, which faces away from the other flange when they are connected as shown in FIGS. 4 and 5. Twelve bores/through holes 234 are provided over the width of the flange 200; in embodiments, different numbers of bores or bolts may be employed, e.g., from 4 to 60 bores/bolts, for example 8, 20, 32, or 40 bolts.

FIG. 7 schematically shows a method for building a mold 150 for a wind turbine rotor blade. The method includes, in a block 1000, providing two mold modules 160, 162, each including at least one mold body 190, 192, having an inverse shape of a part of a rotor blade; and at least one support structure 160, 161 for supporting the mold body; and at least one flange 200, 202 attached to an end portion of the mold body. The method further includes, in a block 1010, positioning the two mold modules 160, 162 such that their flanges are in contact, and thereafter, in block 1020, releasably connecting the two flanges, wherein releasably connecting typically includes connecting the flanges via bolts and/or nuts.

In that sense, releasably connecting may in embodiments additionally or alternatively include applying a vacuum to a space enclosed by the two flanges. It further can include mounting of the support structures of the mold modules.

In embodiments, the described technique of connecting modular mold modules 160, 162 of a mold 150 may also be applied to wind turbine rotor parts other than a rotor blade half. For example, the technique may be applied to molds with which a complete rotor blade can be laminated in one step. To this end, the flange would have to be vacuum tight around the whole circumference of the rotor blade. Further, modular molds can also be applied in the fabrication of shear webs and the like.

The above-described systems and methods facilitate a joining mechanism and method which provide an easy way to change modules of a mold for the production of wind turbine parts.

Exemplary embodiments of systems and methods for a modular mold for producing a rotor blade are described above in detail. The systems and methods are not limited to the specific embodiments described herein, but rather, components of the systems and/or steps of the methods may be utilized independently and separately from other components and/or steps described herein. For example, the mold and methods may be applied for producing rotor blades not related to wind energy production, and are not limited to practice with only the wind turbine systems as described herein. Rather, the exemplary embodiment can be implemented and utilized in connection with many other rotor blade applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. While various specific embodiments have been disclosed in the foregoing, those skilled in the art will recognize that the spirit and scope of the claims allows for equally effective modifications. Especially, mutually non-exclusive features of the embodiments described above may be combined with each other. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A mold module of a modular mold for a wind turbine rotor blade, the mold module comprising:
a) at least one mold body having an inverse shape of a part of a rotor blade;
b) at least one support structure for supporting the at least one mold body; and,
c) at least one flange attached to an end portion of the at least one mold body to releasably mount said mold module to a further mold module of that modular mold.

2. The mold module of claim 1, wherein the at least one flange extends over the width of the at least one mold module.

3. The mold module of claim 1, wherein the at least one flange has a cross-sectional shape of an L.

4. The mold module of claim 1, wherein the at least one flange comprises steel.

5. The mold module of claim 1, wherein the at least one flange is laminated to the at least one mold body, and wherein the mold body is adapted for producing a root portion, a center portion, or a tip portion of a rotor blade.

6. The mold module of claim 1, wherein the flange comprises at least one element from the list consisting of: through holes, and bolts.

7. The mold module of claim 1, wherein the at least one flange comprises at least one circumferential groove for taking up at least one sealing element.

8. The mold module of claim 1, wherein the flange has at least one elongated groove on the face adapted for connection with a second flange, wherein the groove is in fluidal connection with an opening in a different face of the flange.

9. The mold module of claim 1, wherein the mold body is an inverse form of a part of a rotor blade comprising the pressure side or the suction side.

10. The mold module of claim 1, wherein the mold body is an inverse form of a part of a rotor blade including the pressure side and the suction side.

11. A modular mold for a wind turbine rotor blade, comprising:
at least two elongated mold modules, each mold module comprising:
at least one mold body and at least one support structure for supporting the at least one mold body; and at least one flange attached to an end portion of the mold body,
wherein the at least two elongated mold modules are releasably mounted together via at least two flanges.

12. The modular mold of claim 11, wherein the flanges are mounted together by nuts and/or bolts.

13. The modular mold of claim 11, wherein at least one of the flanges has a circumferential groove in its face connected to another flange, and wherein the groove is connected to a pump creating a vacuum in the groove.

14. The modular mold of claim 11, wherein the at least two supporting structures are mounted together via fastening means.

15. A method for building a mold for a wind turbine rotor blade, comprising:
a) providing two mold modules, each comprising
i) at least one mold body having an inverse shape of a part of a rotor blade;
ii) at least one support structure for supporting the mold body; and,
iii) at least one flange attached to an end portion of the mold body;
b) positioning the two mold modules such that their flanges are in contact,
c) releasably connecting the two flanges.

16. The method of claim 15, wherein releasably connecting comprises connecting the flanges via bolts and/or nuts.

17. The method of claim 15, wherein releasably connecting comprises applying a vacuum to a space enclosed by the two flanges.

18. The method of claim 15, further comprising mounting the support structures of the mold modules together.

19. The method of claim 15, wherein the mold body is an inverse shape of a part of a rotor blade comprising the pressure side and/or the suction side.

20. The method of claim 15, further comprising releasing the connection between the flanges and exchanging one of the mold modules with a different mold module.
